(19) United States
(12) Patent Application Publication
(10) Pub. No.: US 2004/0021245 A1
(43) Pub. Date: Feb. 5, 2004

(54) Method of manufacturing cosmetic case

(75) Inventor: Ki Hong Jang, Seoul (KR)

Correspondence Address: LEE, HONG, DEGERMAN, KANG & SCHMADEKA, P.C., 801 SOUTH FIQUEROA STREET, 14TH FLOOR, LOS ANGELES, CA, 90017, US

(73) Assignee: LG Electronics Inc.

(21) Appl. No.: 10/261,238

(22) Filed: Sep. 30, 2002

(30) Foreign Application Priority Data
Aug. 1, 2002 (KR) 2002-45577

(51) Int. Cl. B29C 45/14; B29C 45/16

(52) U.S. Cl. 264/132; 264/259; 264/275; 264/255

(57) ABSTRACT

The present invention relates to a method of manufacturing a cosmetic case formed in a structure of two layers between which is printed a pattern including the logo for a beautiful appearance. The method of manufacturing a cosmetic case comprises the steps of: manufacturing a case core 10 by injecting plastics; forming a pattern 20 on the surface of the case core 10; adding a small amount of hardener and antifoaming agent to Formica stock solution and diluting them; manufacturing a case 40 by hardening and drying after forming a Formica layer 30 on the surface of the case by fixing the case core 10 in the mold and injecting Formica dilute solution; cutting a surface of the case 40; and glossing the surface of the case 40.

### BACKGROUND OF THE INVENTION

1. Field of the Invention

The present invention relates to a method of manufacturing a cosmetic case, and more specifically to a method of manufacturing a cosmetic case formed in a structure of two layers between which is printed a pattern including the logo for a beautiful appearance.

2. Description of the Related Art

Generally, a cosmetic case is composed of a container and a lid, and after putting the contents away in the container, the mouth is covered with the lid to keep the contents.

The general structure and cosmetic case composed like this is made of plastic or glass, etc. and the pattern including the logo and letters is printed directly on the surface or a sticker is attached to show the contents.

Although the quality of the contents is most important for such a cosmetic case, the design of a cosmetic case itself is no less important than the quality of the contents, since the cosmetic case manufactured to stimulate an aesthetic feeling differentiated from other products can trigger a desire to purchase in the woman, the main purchaser.

Therefore, recently in the manufacturing of cosmetic cases, a variety of design and manufacturing are keenly needed to provide products clearly differentiated from those of other companies, free from a stereotyped design.

### SUMMARY OF THE INVENTION

It is an object of the present invention to provide a method of manufacturing a cosmetic case formed in a structure of two layers between which is printed a pattern including the logo for a beautiful appearance.

In accordance with the present invention a method of manufacturing a cosmetic case, comprises the steps of: manufacturing a case core by injecting plastics; forming a pattern on the surface of the case core; adding a small amount of hardener and antifoaming agent to Formica stock solution and diluting them; manufacturing a case by hardening and drying after forming a Formica layer on the surface of the case by fixing the case core in the mold and injecting Formica dilute solution; cutting the surface of the case; and glossing the surface of the case.

### BRIEF DESCRIPTION OF DRAWINGS

Other objects and aspects of the present invention will become apparent from the following description of embodiments with reference to the accompanying drawing in which:

FIG. 1 is a perspective view of a cosmetic case made by the manufacturing method according to the present invention.

FIG. 2 is a plan view of a cosmetic case made by the manufacturing method according to the present invention.

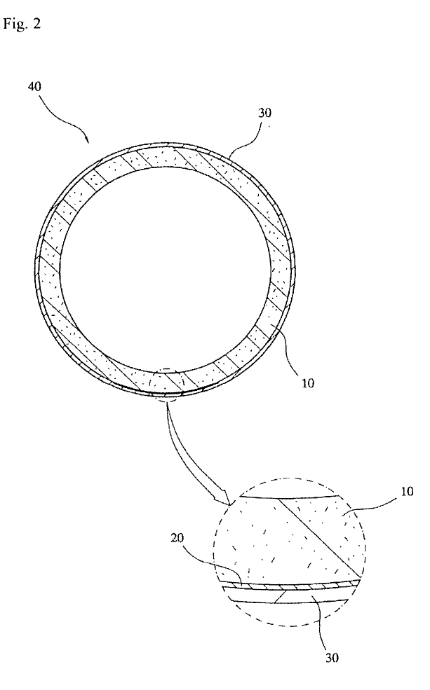

FIG. 3 is a process block diagram illustrating the manufacturing method according to the present invention.

### DESCRIPTION OF THE PREFERRED EMBODIMENT

Below will be described a preferable embodiment of the present invention referring to the attached diagrams.

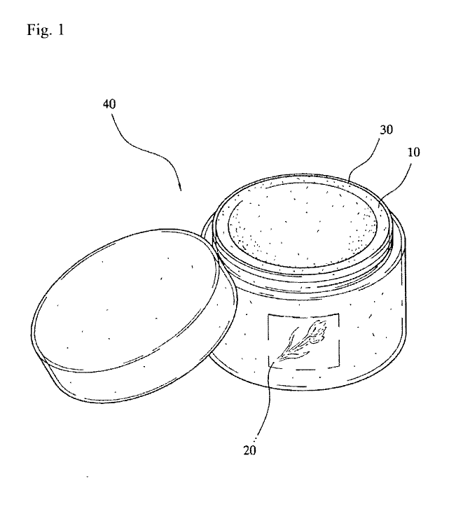

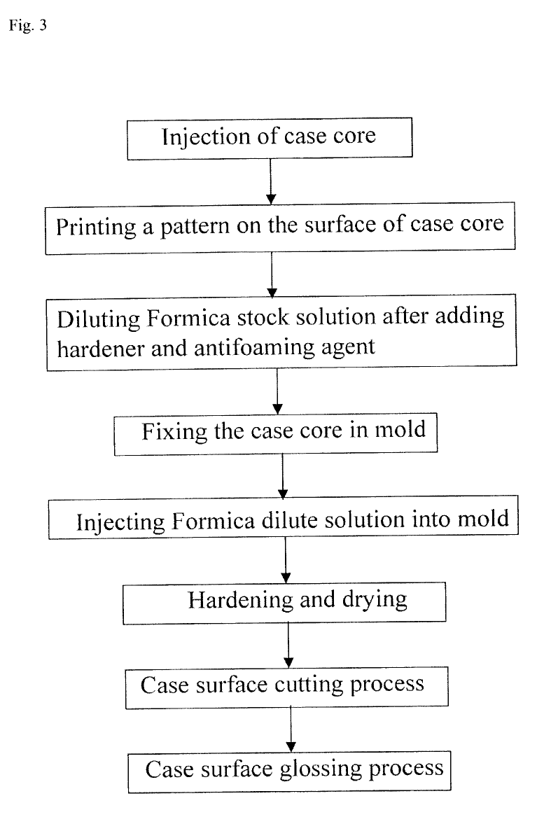

First, as illustrated in FIG. 1, a cosmetic case manufactured according to the present invention has a double structure composed of a case core 10 in a container form and a transparent Formica layer 30 formed on the surface of the case core 10. Between the case core 10 and the Formica layer 30 is placed a pattern 20, which is printed directly on the surface or attached by a sticker. The manufacturing process of the pattern 20 will be described in time series with reference to FIG. 3 as follows:

First, use plastic injection to make the case core 10 in a container form. For injection of the case core 10 like this, it is preferable to manufacture a case core 10 of a beautiful color using resin fusion liquid, a mixture of resin and pigment.

After manufacturing the container-form case core 10 by injection of plastics, form the pattern 20 including the logo and letters on the surface. Here, the pattern 20 can be printed on the surface of the case core 10 or attached in a sticker form, or may be injected in a form imprinted on the surface during injection.

Next, dilute the Formica stock solution by adding a small amount of hardener and antifoaming agent. Formica is generally called unsaturated polyester resin as reinforced plastics, which, as a thermosetting plastic resin, is composed of a chain structure of styrene and polyester with a very strong adhesiveness and a strong gas odor and has a characteristic of hardening through a chemical reaction of combining with hardener. In the present invention, antifoaming agent and hardener are added to discharge and remove the foams generated during casting.

After making Formica dilute solution, fix the case core 10 in the mold and inject Formica dilute solution into the mold (not illustrated) to form the Formica layer 30 on the surface of the case core 10, and then harden and dry it for about 2 hours to make the case 40.

And after taking the hardened and dried case 40 out from the mold, do cutting process on the surface using lathe. This is to process the surface smooth, as the surface of the cast Formica layer 30 is rough and uneven.

Finally after the cutting process on the surface is completed, glossing process is done on the surface of the case 40. Here, use a fine-grained sandpaper to process the surface of the case 40 that was cut with lathe, and coat with glaze, and finally perform surface glossing work.

The cosmetic case made by the manufacturing method according to the present invention has a double structure composed of the case core 10 having a beautiful color on the inside and the transparent Formica layer 30 having gloss on the surface. And since the pattern 20 is located between the case core 10 and the Formica layer 30, and compared with the conventional cosmetic case composed only of plastics or glass and has a simple design with a pattern printed on the surface, the appearance is beautiful and unique so that it suits the taste of the people of the present generation who pursue novelty and individuality.

The present invention can be applied not only to the cosmetic case composed of a container and a lid but also to a cosmetic case such as a compact. The method according to the present invention can be applied also to manufacture of a cosmetic brush handle, hairbrush handle, or mirror handle.

What is claimed is:

1. A method of manufacturing a cosmetic case, comprising the steps of:
manufacturing a case core by injecting plastics;
forming a pattern on the surface of said case core;
adding a small amount of hardener and antifoaming agent to Formica stock solution and diluting them;
manufacturing a case by hardening and drying after forming a Formica layer on the surface of the case by fixing the case core in the mold and injecting Formica dilute solution;
cutting the surface of said case; and
glossing the surface of said case.
